(19) United States
(12) Patent Application Publication
(10) Pub. No.: US 2012/0166133 A1
(43) Pub. Date: Jun. 28, 2012

(54) Electronic device, pedometer, and program

(76) Inventor: Tomohiro Ihashi, Chiba-shi (JP)

(21) Appl. No.: 13/374,140

(22) Filed: Dec. 13, 2011

(30) Foreign Application Priority Data
Dec. 24, 2010 (JP) 2010-288405

(51) Int. Cl. G06F 15/00; G01P 15/00

(52) U.S. Cl. 702/141; 73/488

(57) ABSTRACT

A device has three acceleration sensors, one that detects an acceleration in a first direction to output a first signal, another that detects an acceleration in a second direction, orthogonal to the first direction, to output a second signal, and a third that detects an acceleration in a third direction, orthogonal to a plane uniquely identified by the first and second directions, to output a third signal. A CPU obtains one or more signals from among the first, second, and third signals to detect a walk by using the obtained signals. The CPU determines a posture of the device on the basis of a moving average value of the first signals, a moving average value of the second signals, and a moving average value of the third signals. The CPU stops the walk detecting operation on the basis of a change of the determined posture.

### BACKGROUND OF THE INVENTION

1. Field of the Invention

The present invention relates to an electronic device, a pedometer, and a program for counting the number of steps during walking or running.

2. Description of the Related Art

Conventionally, there is a pedometer which uses an acceleration sensor or other body motion sensor to detect a body movement of a wearer caused by a walk, and counts the detected body motions to thereby detect the number of steps taken by the wearer during walking or running. There is also known a pedometer in which, when it is determined on the basis of signals from walk detecting means that a wearer has stopped walking, the operation of the walk detecting means is switched from a continuous operation for continuously detecting a walk to an intermittent operation for repeating operation and stop in a predetermined cycle, for the purposes of reducing the power consumed by the pedometer (see, for example, Patent Document 1).

[Patent Document 1] Japanese Patent Application Laid-Open No. 2005-267152

With the pedometer disclosed in Patent Document 1 above, however, when the pedometer is actually worn by a user, the walk detecting means will output signals by detecting various motions in daily life other than a walk. This requires the pedometer to determine whether the user has started walking again every time a signal is output from the walk detecting means, hindering a reduction in power consumption by the pedometer while the same is being worn by the user. Particularly in the case of a pedometer which is worn around an arm, the arm is moved frequently not only in the walking state but also in the other states (in the seated state, for example), thereby making it difficult to reduce the power consumption while the pedometer is being worn by the user.

### SUMMARY OF THE INVENTION

It is an aspect of the present application to provide an electronic device, a pedometer, and a program which enable a further reduction in power consumption even in the state where a user is wearing the same.

The present application provides an electronic device including: a first acceleration sensor which detects an acceleration in a first direction to output a first signal corresponding to the acceleration; a second acceleration sensor which detects an acceleration in a second direction orthogonal to the first direction to output a second signal corresponding to the acceleration; a third acceleration sensor which detects an acceleration in a third direction orthogonal to a plane uniquely identified by the first and second directions to output a third signal corresponding to the acceleration; a walk detecting unit which obtains one or more signals from among the first, second, and third signals to detect a walk by using the obtained signals; a posture determination unit which obtains the first, second, and third signals to determine a posture of the electronic device on the basis of a moving average value of the first signals, a moving average value of the second signals, and a moving average value of the third signals; and a control unit which stops an operation of the walk detecting unit on the basis of a change of the posture determined by the posture determination unit.

In the electronic device of the present application, the control unit controls such that, while the operation of the walk detecting unit is being stopped, the signals are obtained in a cycle which is longer than a cycle that is applied while the walk detecting unit is in operation.

Further, in the electronic device of the present application, the control unit stops power supply to the walk detecting unit while the control unit stops the operation of the walk detecting unit.

Further, in the electronic device of the present application, the control unit stops the operation of the walk detecting unit in the case where the posture determined by the posture determination unit has changed at least a fixed number of times within a predetermined period.

Further, in the electronic device of the present application, the control unit stops the operation of the walk detecting unit in the case where the posture determined by the posture determination unit has changed within a fixed period of time and the posture has changed at least a fixed number of times continuously within the fixed period of time.

Further, in the electronic device of the present application, the control unit stops the operation of the walk detecting unit in the case where the posture determination unit has determined at least a fixed number of kinds of postures within a predetermined period.

Further, in the electronic device of the present application, the control unit restarts the operation of the walk detecting unit when a fixed period of time has elapsed since the control unit stopped the operation of the walk detecting unit.

Further, in the electronic device of the present application, the control unit restarts the operation of the walk detecting unit in the case where the number of changes of the posture determined by the posture determination unit within a predetermined period has become less than a fixed number of times after the control unit stopped the operation of the walk detecting unit.

Further, in the electronic device of the present application, in the case where the control unit had controlled such that the signals would be obtained in a cycle which is longer than an original cycle that is applied while the walk detecting unit is in operation, the control unit returns the cycle back to the original cycle when restarting the operation of the walk detecting unit.

Further, in the electronic device of the present application, in the case where the control unit had stopped the power supply to the walk detecting unit, the control unit restarts the power supply to the walk detecting unit when restarting the operation of the walk detecting unit.

The electronic device of the present application further includes an input unit which accepts an input from a user, wherein after the control unit has stopped the operation of the walk detecting unit, the control unit restarts the operation of the walk detecting unit in the case where the input unit has accepted an input.

Further, in the electronic device of the present application, after the control unit has stopped the operation of the walk detecting unit, the control unit restarts the operation of the walk detecting unit in the case where the posture determination unit determines that the device has attained a predetermined posture.

The present application further provides a pedometer including: a first acceleration sensor which detects an acceleration in a first direction to output a first signal corresponding to the acceleration; a second acceleration sensor which detects an acceleration in a second direction orthogonal to the first direction to output a second signal corresponding to the acceleration; a third acceleration sensor which detects an acceleration in a third direction orthogonal to a plane uniquely identified by the first and second directions to output a third signal corresponding to the acceleration; a walk detecting unit which obtains one or more signals from among the first, second, and third signals to detect a walk by using the obtained signals; a posture determination unit which obtains the first, second, and third signals to determine a posture of the pedometer on the basis of a moving average value of the first signals, a moving average value of the second signals, and a moving average value of the third signals; and a control unit which stops an operation of the walk detecting unit on the basis of a change of the posture determined by the posture determination unit.

The present application further provides a program which causes a computer to perform: a first acceleration detecting step of detecting an acceleration in a first direction to output a first signal corresponding to the acceleration; a second acceleration detecting step of detecting an acceleration in a second direction orthogonal to the first direction to output a second signal corresponding to the acceleration; a third acceleration detecting step of detecting an acceleration in a third direction orthogonal to a plane uniquely identified by the first and second directions to output a third signal corresponding to the acceleration; a walk detecting step of obtaining one or more signals from among the first, second, and third signals to detect a walk by using the obtained signals; a posture determination step of obtaining the first, second, and third signals to determine a posture of the own device on the basis of a moving average value of the first signals, a moving average value of the second signals, and a moving average value of the third signals; and a control step of stopping an operation of the walk detecting step on the basis of a change of the posture determined in the posture determination step.

According to the present application, the first acceleration sensor detects an acceleration in a first direction to output a first signal corresponding to the acceleration. The second acceleration sensor detects an acceleration in a second direction orthogonal to the first direction, to output a second signal corresponding to the acceleration. The third acceleration sensor detects an acceleration in a third direction orthogonal to a plane uniquely identified by the first and second directions, to output a third signal corresponding to the acceleration. The walk detecting unit obtains one or more signals from among the first, second, and third signals to use the obtained signals to detect a walk. The posture determination unit obtains the first, second, and third signals to determine a posture of the own device on the basis of a moving average value of the first signals, a moving average value of the second signals, and a moving average value of the third signals. The control unit stops the operation of the walk detecting unit on the basis of a change of the posture determined by the posture determination unit. This enables the operation of the walk detecting unit to be stopped on the basis of a change in posture of the own device. As a result, it is possible to further reduce the power consumption even in the state where the device is worn by a user.

### BRIEF DESCRIPTION OF THE DRAWINGS

FIG. 1 is an external view of a pedometer according to an embodiment of the present invention;

FIG. 2 is a cross-sectional view of the pedometer of the present embodiment;

FIG. 3 is a block diagram illustrating a configuration of the pedometer of the present embodiment;

FIG. 4 schematically illustrates the X-, Y-, and Z-axis directions in the state where a user is wearing the pedometer in the present embodiment;

FIG. 5 is a graph illustrating the magnitudes of moving average accelerations in the X-, Y-, and Z-axis directions which are detected in accordance with the posture of the pedometer while the user is walking in the present embodiment;

FIG. 6 is a graph illustrating the magnitude of the resultant acceleration obtained from the accelerations in the X-, Y-, and Z-axis directions, detected by the pedometer while the user is walking in the present embodiment;

FIG. 7 is a flowchart illustrating processing procedure of a candidate detecting process which is carried out by the pedometer of the present embodiment;

FIG. 8 is a flowchart illustrating processing procedure of a step number counting process which is carried out by the pedometer of the present embodiment;

FIG. 9 is a flowchart illustrating processing procedure of a posture determination process which is carried out by the pedometer of the present embodiment;

FIG. 10 is a flowchart illustrating processing procedure, in the present embodiment, for stopping the walk detecting process in the case where the posture of the pedometer has changed;

FIG. 11 is a flowchart illustrating processing procedure, in the present embodiment, for stopping the walk detecting process in the case where the posture of the pedometer has changed and for further setting the acceleration detecting cycle in the posture determination process to be longer than that in the walk detecting process;

FIG. 12 is a flowchart illustrating processing procedure, in the present embodiment, for stopping the walk detecting process in the case where the posture of the pedometer has changed and for further shutting down the power supply to a walk detecting circuit;

FIG. 13 is a flowchart illustrating processing procedure, in the present embodiment, for stopping the walk detecting process in the case where the posture of the pedometer has changed at least a fixed number of times within a predetermined period;

FIG. 14 is a flowchart illustrating processing procedure, in the present embodiment, for stopping the walk detecting process in the case where the posture of the pedometer has changed within a fixed period of time and the posture has changed at least a fixed number of times continuously within the fixed period of time;

FIG. 15 is a flowchart illustrating processing procedure, in the present embodiment, for stopping the walk detecting process in the case where the pedometer has taken at least a fixed number of kinds of postures within a predetermined period;

FIG. 16 is a flowchart illustrating processing procedure, in the present embodiment, for restarting the walk detecting process in the case where a fixed period of time has elapsed since the walk detecting process was stopped;

FIG. 17 is a flowchart illustrating processing procedure, in the present embodiment, for restarting the walk detecting process in the case where the number of changes of the posture of the pedometer within a predetermined period has become less than a fixed number of times after the walk detecting process was stopped; and

FIG. 18 is a flowchart illustrating processing procedure, in the present embodiment, for restarting the walk detecting process in the case where the pedometer has attained a posture in which its orientation coincides with that in normal walking after the walk detecting process was stopped.

### DESCRIPTION OF THE PREFERRED EMBODIMENTS

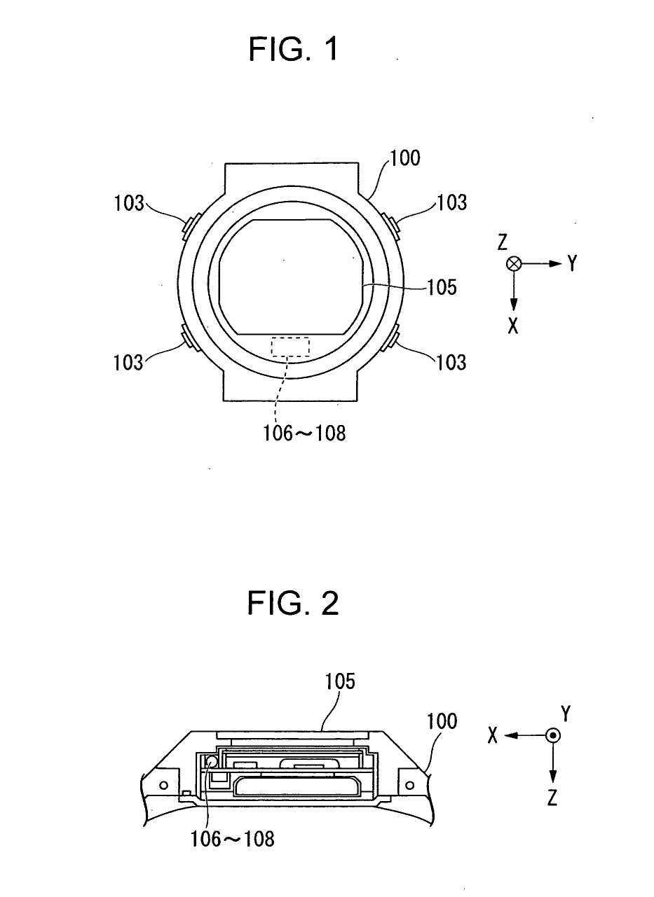

Hereinafter, an embodiment of the present invention will be described with reference to the drawings. In the present embodiment, a pedometer will be described as an example of an electronic device. FIG. 1 is an external view of the pedometer according to the present embodiment. FIG. 2 is a cross-sectional view of the pedometer of the present embodiment. In the example shown in FIGS. 1 and 2, a pedometer 100 has a display unit 105 provided on its upper surface and an input unit 103 provided on its side surface. The pedometer 100 further includes acceleration sensors 106 to 108 therein.

The display unit 105 has a display surface and displays the number of steps and others thereon. The input unit 103 accepts an input from a user of the pedometer 100. The acceleration sensors 106 to 108 detect X, Y, and Z components of the orthogonal coordinate axes which are orthogonal to each other, and output acceleration signals whose magnitudes correspond to the accelerations of the respective components.

In the present embodiment, the acceleration sensor 106 detects an acceleration X in the X-axis direction, the acceleration sensor 107 detects an acceleration Y in the Y-axis direction, and the acceleration sensor 108 detects an acceleration Z in the Z-axis direction. In the present embodiment, a plane which is flush with the display surface of the display unit 105 in the pedometer 100 is defined as the XY plane, and a direction which is perpendicular to the display surface of the display unit 105 is defined as the Z-axis direction. The pedometer 100 shown here is a wristwatch-type pedometer which is worn around a user's arm for use.

The acceleration sensors 106 to 108 may be configured, for example, with one micro electro-mechanical systems (MEMS) triaxial acceleration sensor, or with three uniaxial acceleration sensors which are arranged in three axial directions orthogonal to each other.

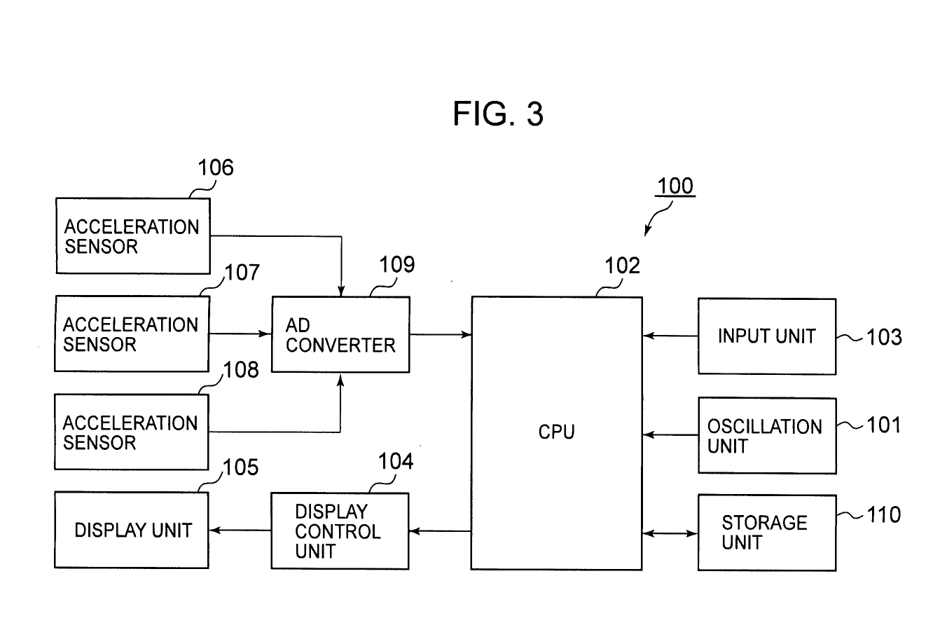

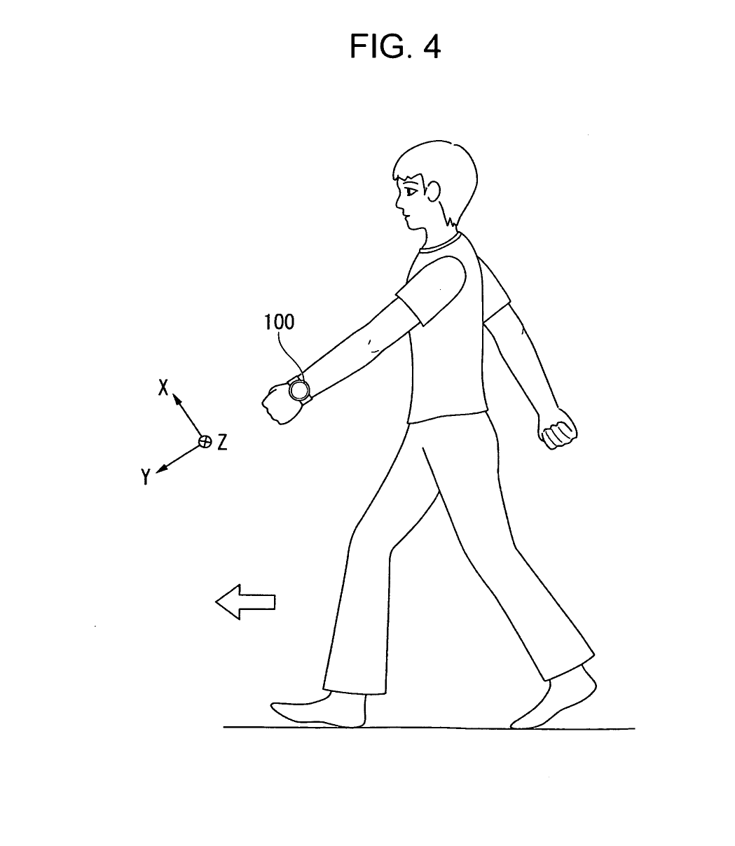

FIG. 3 is a block diagram illustrating a configuration of the pedometer 100 according to the present embodiment. In the illustrated example, the pedometer 100 includes an oscillation unit 101, a central processing unit (CPU) 102 (control unit), an input unit 103, a display control unit 104, a display unit 105, an acceleration sensor 106 (first acceleration sensor), an acceleration sensor 107 (second acceleration sensor), an acceleration sensor 108 (third acceleration sensor), an AD converter 109, and a storage unit 110.

The oscillation unit 101 generates a clock signal as a basis for timekeeping, and a reference clock signal for operation of the CPU 102. The CPU 102 carries out a process of calculating the number of steps, a walk/run determination process for determining whether a user is walking or running, control of various electronic circuit elements constituting the pedometer, a timekeeping operation, and others. The input unit 103 accepts inputs from a user which instruct to start or stop counting the number of steps, and others. The display control unit 104, in response to control signals from the CPU 102, causes the display unit 105 to display the number of steps, the walking or running distance, the time, the energy consumption, and others. The display unit 105 is made up of a liquid crystal display (LCD), and displays the number of steps, the walking or running distance, the time, the energy consumption, and others.

The acceleration sensors 106 to 108 detect the X component, Y component, and Z component, respectively, of the orthogonal coordinate axes which are orthogonal to each other, and output acceleration signals whose magnitudes correspond to the accelerations of the respective components. The storage unit 110 stores a program executed by the CPU 102, data necessary for the units in the pedometer 100 to perform processing, and others. In the present embodiment, the CPU 102, for example, operates as a walk detecting unit, a posture determination unit, and a control unit of the present invention.

The X-axis direction, Y-axis direction, and Z-axis direction in the state where the pedometer 100 is being worn by a user will now be described. FIG. 4 schematically illustrates the X-, Y-, and Z-axis directions in the state where a user is wearing the pedometer 100 in the present embodiment. As shown in the figure, in the case where the pedometer 100 is worn around an arm of the user, the direction from the elbow toward the palm of the hand is the Y-axis direction, and the direction perpendicular to the palm of the hand is the Z-axis direction. The direction which is perpendicular to the plane that is uniquely determined by the Y-axis direction and the Z-axis direction is the X-axis direction.

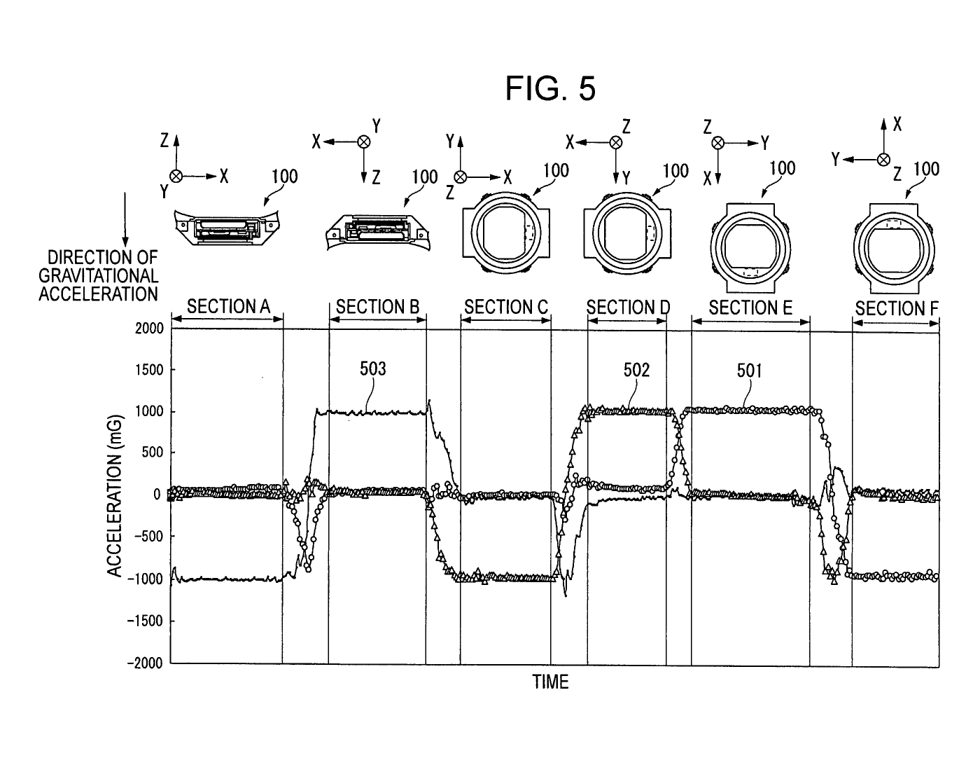

The magnitudes of moving average accelerations in the X-, Y-, and Z-axis directions which are detected in accordance with the posture of the pedometer 100 while the user is walking will now be described. FIG. 5 is a graph illustrating the magnitudes of the moving average accelerations in the X-, Y-, and Z-axis directions which are detected in accordance with the posture of the pedometer 100 while the user is walking in the present embodiment. In the illustrated example, the horizontal axis represents time, and the vertical axis represents the magnitude of the moving average acceleration [mG] which is an average of accelerations during the last two seconds. A line 501 represents the magnitude of moving average acceleration X in the X-axis direction, a line 502 represents the magnitude of moving average acceleration Y in the Y-axis direction, and a line 503 represents the magnitude of moving average acceleration Z in the Z-axis direction.

As shown in a section A in FIG. 5, in the case where a user wearing the pedometer 100 walks in a posture with the Z-axis direction upward (where the Z-axis direction is opposite from the direction of the gravitational acceleration), the pedometer 100 detects that the moving average accelerations in the X-axis direction and in the Y-axis direction are both about 0 mG and the moving average acceleration in the Z-axis direction is about −1000 mG. Here, the posture of the pedometer 100 at this time is assumed to be a posture “a”. Further, as shown in a section B in FIG. 5, in the case where a user wearing the pedometer 100 walks in a posture with the Z-axis direction downward (where the Z-axis direction coincides with the direction of the gravitational acceleration), the pedometer 100 detects that the moving average accelerations in the X-axis direction and in the Y-axis direction are both about 0 mG and the moving average acceleration in the Z-axis direction is about 1000 mG. The posture of the pedometer 100 at this time is assumed to be a posture “b”.

Further, as shown in a section C in FIG. 5, in the case where a user wearing the pedometer 100 walks in a posture with the Y-axis direction upward (where the Y-axis direction is opposite from the direction of the gravitational acceleration), the pedometer 100 detects that the moving average accelerations in the X-axis direction and in the Z-axis direction are both about 0 mG and the moving average acceleration in the Y-axis direction is about −1000 mG. The posture of the pedometer 100 at this time is assumed to be a posture “c”. Further, as shown in a section D in FIG. 5, in the case where a user wearing the pedometer 100 walks in a posture with the Y-axis direction downward (where the Y-axis direction coincides with the direction of the gravitational acceleration), the pedometer 100 detects that the moving average accelerations in the X-axis direction and in the Z-axis direction are both about 0 mG and the moving average acceleration in the Y-axis direction is about 1000 mG. The posture of the pedometer 100 at this time is assumed to be a posture “d”.

Still further, as shown in a section E in FIG. 5, in the case where a user wearing the pedometer 100 walks in a posture with the X-axis direction downward (where the X-axis direction coincides with the direction of the gravitational acceleration), the pedometer 100 detects that the moving average accelerations in the Y-axis direction and in the Z-axis direction are both about 0 mG and the moving average acceleration in the X-axis direction is about 1000 mG. The posture of the pedometer 100 at this time is assumed to be a posture “e”. Further, as shown in a section F in FIG. 5, in the case where a user wearing the pedometer 100 walks in a posture with the X-axis direction upward (where the X-axis direction is opposite from the direction of the gravitational acceleration), the pedometer 100 detects that the moving average accelerations in the Y-axis direction and in the Z-axis direction are both about 0 mG and the moving average acceleration in the X-axis direction is about −1000 mG. The posture of the pedometer 100 at this time is assumed to be a posture “f”.

As described above, the moving average acceleration in the X-axis direction, the moving average acceleration in the Y-axis direction, and the moving average acceleration in the Z-axis direction detected by the pedometer 100 vary in accordance with the posture of the pedometer 100. This enables the pedometer 100 to determine the posture of the pedometer 100 on the basis of the moving average accelerations in the X-, Y-, and Z-axis directions.

In general, a user swings the arms at regular intervals while walking or running, which causes only a slight change in posture of the pedometer 100. However, once the user stops walking or running to do another task, the user would often change the orientations of the arms. Accordingly, in the case where the posture of the pedometer 100 has changed, the pedometer 100 is able to determine that the user has stopped walking or running, and thus to stop the walk detecting process. Even when the acceleration sensors 106 to 108 output signals, if the posture of the pedometer 100 changes continuously, the pedometer 100 is able to determine that the user has not restarted walking or running.

Accordingly, even in the case where the acceleration sensors 106 to 108 output signals, the pedometer 100 is able to keep the walk detecting process stopped, without determining that the user has started walking or running. Therefore, even in the state where the pedometer 100 is being worn by a user, the pedometer 100 is able to determine that the user has stopped walking or running and thus to stop the walk detecting process. This enables a further reduction in power consumption.

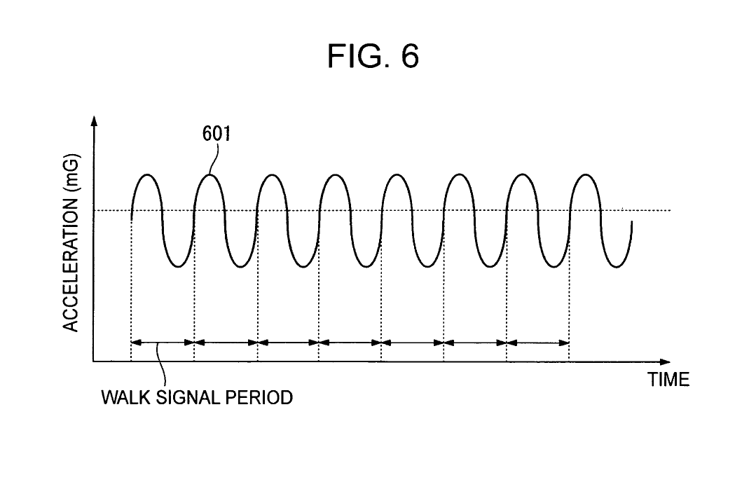

The magnitude of the acceleration which is detected by the pedometer 100 while the user is walking will now be described. FIG. 6 is a graph illustrating the magnitude of the resultant acceleration obtained from the accelerations in the X-, Y-, and Z-axis directions, detected by the pedometer 100 while the user is walking in the present embodiment. In the illustrated example, the horizontal axis represents time, and the vertical axis represents the magnitude of the resultant acceleration [mG]. A curve 601 represents the magnitude of the resultant acceleration obtained from the accelerations in the X-, Y-, and Z-axis directions. A cycle of the curve 601 corresponds to a walk signal period. The walk signal period, which depends on the pace of walking of the user, is generally less than one second.

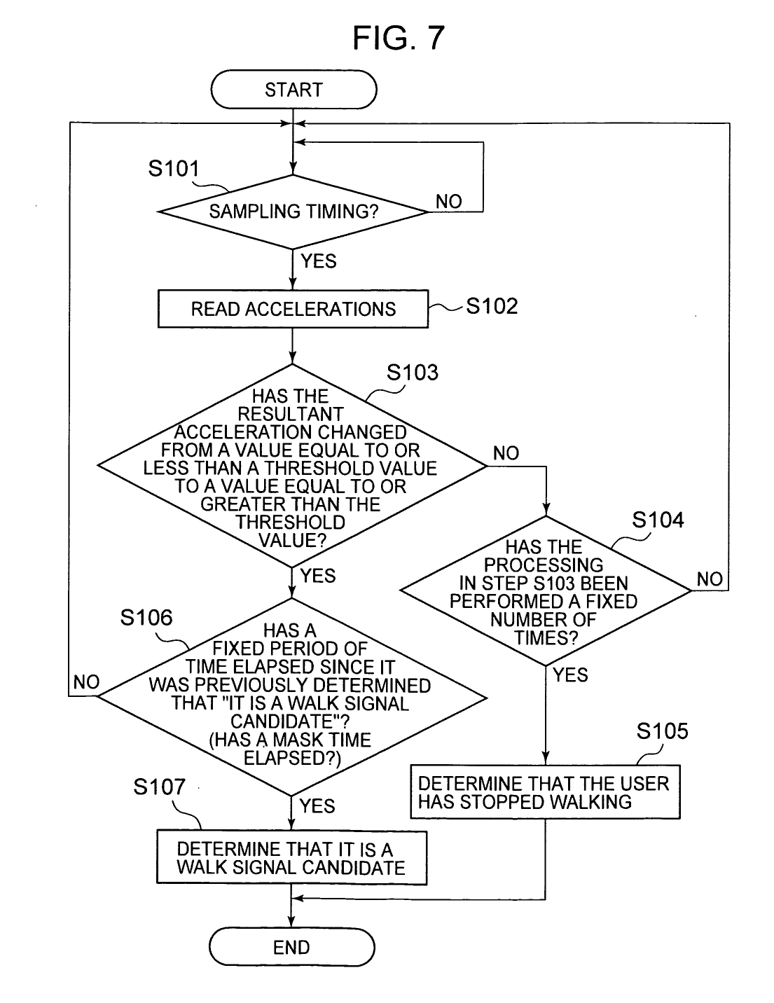

Hereinafter, processing procedure of a candidate detecting process performed by the pedometer 100 to detect a candidate for a walk signal will be described. FIG. 7 is a flowchart illustrating processing procedure of the candidate detecting process which is carried out by the pedometer 100 of the present embodiment. The pedometer 100 carries out the candidate detecting process repeatedly. In the following description, a resultant output obtained from the outputs of the acceleration sensors 106 to 108 is used to detect the walk signal candidate. Alternatively, one or more of the outputs from the acceleration sensors 106 to 108 may be used to detect the walk signal candidate.

(Step S101) The CPU 102 determines whether it is time (sampling timing) to perform the processing in step S102 and on. If the CPU 102 determines that it is the sampling timing, the process proceeds to step S102. Otherwise, the processing in step S101 is performed again. For example, in the case where the sampling timing is set to be every 50 ms, the CPU 102 performs the processing in step S102 and on every 50 ms. In other words, the CPU 102 performs the processing in step S102 and on at the interval (sampling interval) of 50 ms. The sampling interval is desirably set to be 50 to 100 ms.

(Step S102) The CPU 102 obtains output values of the acceleration sensors 106, 107, and 108 at the sampling timing, which have been converted into digital signals by the AD converter 109, and calculates a resultant output value. The process then proceeds to step S103. For example, in the case where the sampling interval is set to be 50 ms, the AD converter 109 outputs the output values of the acceleration sensors 106, 107, and 108 every 50 ms. The CPU 102 obtains the output values of the acceleration sensors 106, 107, and 108 which are output from the AD converter 109 every 50 ms, to calculate the resultant output value.

(Step S103) The CPU 102 determines whether the resultant output value of the acceleration sensors 106, 107, and 108 at the sampling timing, calculated in step S102, has changed from a value equal to or less than a threshold value to a value equal to or greater than the threshold value. If the CPU 102 determines that the resultant output value of the acceleration sensors 106, 107, and 108 at the sampling timing, calculated in step S102, has changed from a value equal to or less than the threshold value to a value equal to or greater than the threshold value, then the process proceeds to step S106; otherwise, the process proceeds to step S104. For example, in the case where the threshold value is 1200 mG and the resultant output value of the acceleration sensors 106, 107, and 108 changed from 1150 mG to 1250 mG, then the CPU 102 determines that the resultant output value of the acceleration sensors 106, 107, and 108 has changed from a value equal to or less than the threshold value to a value equal to or greater than the threshold value.

(Step S104) The CPU 102 determines whether the processing in step S103 has been performed a fixed number of times. If the CPU 102 determines that the processing in step S103 has been performed the fixed number of times, the process proceeds to step S105; otherwise, the process returns to step S101. The fixed number of times may be ten, for example.

(Step S105) The CPU 102 determines that the user has stopped walking, and then the candidate detecting process is terminated.

(Step S106) The CPU 102 determines whether a fixed period of time has elapsed since it previously determined a walk signal candidate. If the CPU 102 determines that the fixed period of time (mask time) has elapsed since it previously determined the walk signal candidate, the process proceeds to step S107; otherwise, the process returns to step S101. It may be configured such that the mask time is determined arbitrarily in accordance with the environment.

(Step S107) The CPU 102 determines that the resultant output value of the acceleration sensors 106, 107, and 108, calculated in step S102, is a candidate for a walk signal. The candidate detecting process is then terminated.

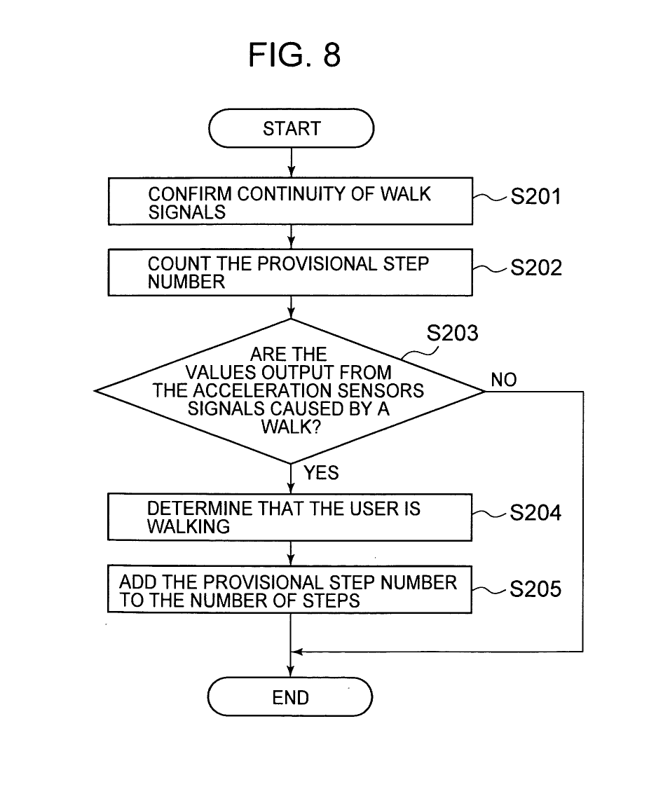

Hereinafter, processing procedure of a step number counting process performed by the pedometer 100 to count the number of steps will be described. FIG. 8 is a flowchart illustrating processing procedure of the step number counting process which is carried out by the pedometer 100 of the present embodiment. The pedometer 100 carries out the step number counting process repeatedly.

(Step S201) The CPU 102 determines whether the walk signal candidates detected in the candidate detecting process are continuous (i.e., it confirms continuity thereof). The process then proceeds to step S202. For example, in the case where six or more walk signal candidates have been detected at an interval of one second or less during six seconds, then it is determined that the walk signal candidates are continuous.

(Step S202) The CPU 102 counts, as a provisional step number, the number of walk signal candidates that have been detected in the detecting process after the step number was added previously in step S205. The process then proceeds to step S203.

(Step S203) In the case where the CPU 102 determines in step S201 that the walk signal candidates are continuous, the CPU 102 determines that the values output from the acceleration sensors 106, 107, and 108 are signals caused by a walk. If the CPU 102 determines that the output values from the acceleration sensors 106, 107, and 108 are the signals caused by a walk, the process proceeds to step S204; otherwise, the process is terminated.

(Step S204) The CPU 102 determines that the user is walking. Thereafter, the process proceeds to step S205.

(Step S205) The CPU 102 adds the provisional step number, which has been counted in step S202, to the number of steps. The step number counting process is then terminated.

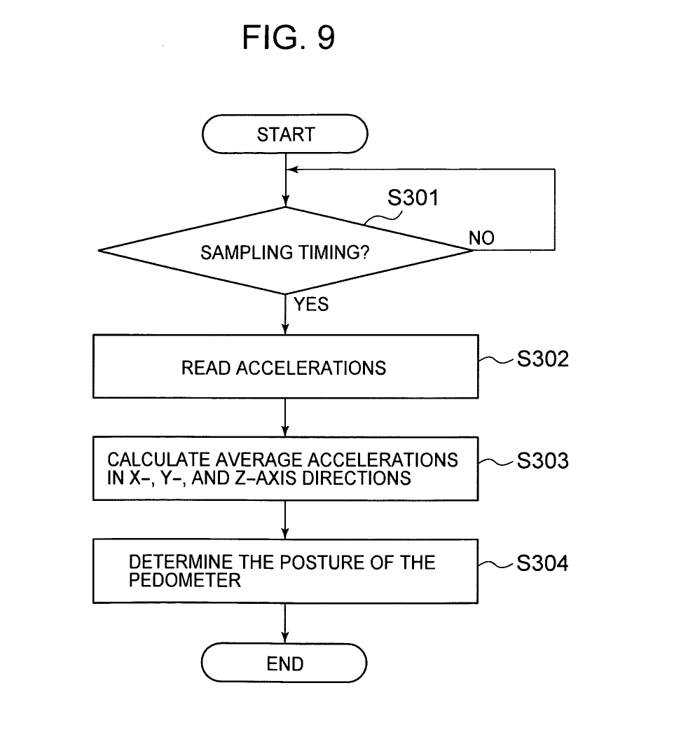

Hereinafter, a posture determination process performed by the pedometer 100 to determine the posture of the pedometer 100 will be described. FIG. 9 is a flowchart illustrating processing procedure of the posture determination process which is carried out by the pedometer 100 of the present embodiment. The pedometer 100 carries out the posture determination process repeatedly.

(Step S301) The CPU 102 determines whether it is time (sampling timing) to perform the processing in step S302 and on. If the CPU 102 determines that it is the sampling timing, the process proceeds to step S302. Otherwise, the processing in step S301 is performed again. For example, in the case where the sampling timing is set to be every 50 ms, the CPU 102 performs the processing in step S302 and on every 50 ms. In other words, the CPU 102 performs the processing in step S302 and on at the interval (sampling interval) of 50 ms. The sampling timing is desirably set to be every 50 to 100 ms.

(Step S302) The CPU 102 obtains the values which have been output from the acceleration sensors 106, 107, and 108 in the past two seconds, which values have been converted into digital signals by the AD converter 109. The process then proceeds to step S303. For example, in the case where the AD converter 109 outputs, every 50 ms, the values output from the acceleration sensors 106, 107, and 108, the CPU 102 obtains 40 values output from the acceleration sensor 106, 40 values output from the acceleration sensor 107, and 40 values output from the acceleration sensor 108, which were output from the AD converter 109 in the past two seconds. While it is configured in the present embodiment to obtain the values output from the acceleration sensors 106, 107, and 108 in the past two seconds, not restricted thereto, it may be configured to obtain the values output therefrom in any given period of time.

(Step S303) The CPU 102 calculates an average value of the values output from the acceleration sensor 106 in the past two seconds (moving average acceleration in the X-axis direction), an average value of the values output from the acceleration sensor 107 in the past two seconds (moving average acceleration in the Y-axis direction), and an average value of the values output from the acceleration sensor 108 in the past two seconds (moving average acceleration in the Z-axis direction), which were obtained in step S302. The process then proceeds to step S304.

(Step S304) The CPU 102 determines the posture of the pedometer 100 on the basis of the moving average acceleration in the X-axis direction, the moving average acceleration in the Y-axis direction, and the moving average acceleration in the Z-axis direction, which were calculated in step S303. The posture determination process is then terminated. The relation of the moving average accelerations in the X-, Y-, and Z-axis directions with the postures of the pedometer 100 is as described above in conjunction with FIG. 5. For example, when the moving average acceleration in the X-axis direction is about 0 mG, the moving average acceleration in the Y-axis direction is about 0 mG, and the moving average acceleration in the Z-axis direction is about −1000 mG, then the CPU 102 determines that the pedometer 100 is in the posture “a”. The CPU 102 determines the postures “b” to “f” similarly on the basis of the relation shown in FIG. 5.

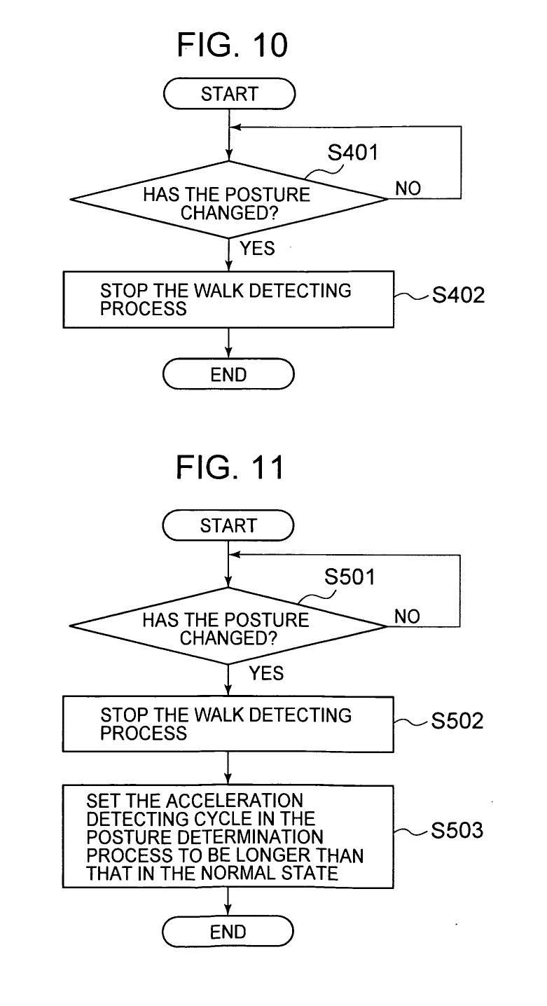

Hereinafter, processing performed by the CPU 102 to stop the walk detecting process on the basis of the change in posture of the pedometer 100 determined in the posture determination process will be described. In the following, six examples will be described with reference to FIGS. 10 to 15. It is noted that the candidate detecting process and the step number counting process will be collectively called the walk detecting process.

FIG. 10 is a flowchart illustrating processing procedure, in the present embodiment, for stopping the walk detecting process in the case where the posture of the pedometer 100 has changed.

(Step S401) The CPU 102 determines whether the posture of the pedometer 100 has changed, on the basis of the result of the posture determination process. If the CPU 102 determines that the posture of the pedometer 100 has changed, the process proceeds to step S402. Otherwise, the processing in step S401 is performed again. For example, assume that the posture of the pedometer 100 was determined to be the posture “a” in the previous posture determination process and it has been determined to be the posture “b” in the current posture determination process. In this case, the CPU 102 determines that the posture of the pedometer 100 has changed.

(Step S402) The CPU 102 stops the walk detecting process. The process is then terminated.

In this manner, the pedometer 100 is able to determine that the user has stopped walking or running, on the basis of the posture of the pedometer 100. Therefore, even in the case where the acceleration sensors 106 to 108 output signals, the pedometer 100 is able to keep the walk detecting process stopped, without determining that the user has started walking or running. Accordingly, even in the state where the pedometer 100 is being worn by a user, the pedometer 100 is able to determine that the user has stopped walking or running and thus to stop the walk detecting process. This enables a further reduction in power consumption.

FIG. 11 is a flowchart illustrating processing procedure, in the present embodiment, for stopping the walk detecting process in the case where the posture of the pedometer 100 has changed and for further setting an acceleration detecting cycle in the posture determination process to be longer (e.g., every 0.5 seconds) than a normal cycle (e.g., every 0.08 seconds) which is applied while a walk is being detected.

The processing in steps S501 and S502 is identical to the processing in steps S401 and S402 shown in FIG. 10.

(Step S503) The CPU 102 sets the acceleration detecting cycle in the posture determination process to be longer than that in a normal state where a walk is being detected. The process is then terminated.

In this manner, the pedometer 100 sets the acceleration detecting cycle in the posture determination process to be longer than that in the normal state where a walk is being detected. This enables a further reduction in power consumption.

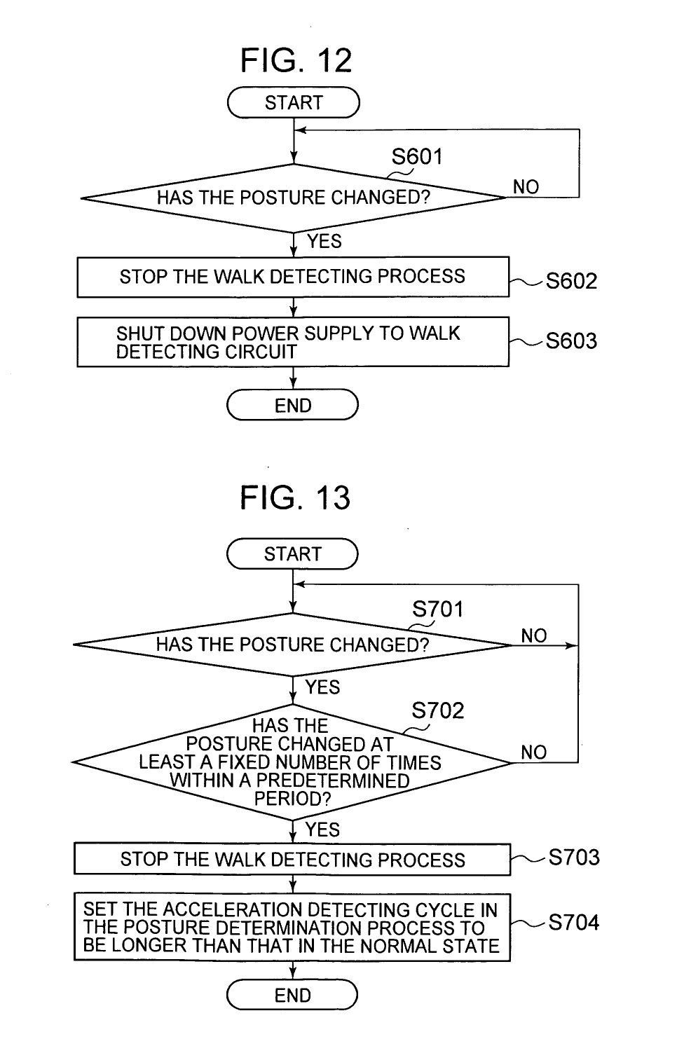

FIG. 12 is a flowchart illustrating processing procedure, in the case where the pedometer 100 uses a walk detecting circuit (not shown) to perform the walk detecting process in the present embodiment, for stopping the walk detecting process when the posture of the pedometer 100 has changed and for further shutting down the power supply to the walk detecting circuit.

The processing in steps S601 and S602 is identical to the processing in steps S401 and S402 shown in FIG. 10.

(Step S603) The CPU 102 shuts down the power supply to the walk detecting circuit. The process is then terminated.

In this manner, the pedometer 100 shuts down the power supply to the walk detecting circuit, thereby enabling a further reduction in power consumption.

FIG. 13 is a flowchart illustrating processing procedure, in the present embodiment, for stopping the walk detecting process in the case where the posture of the pedometer 100 has changed at least a fixed number of times within a predetermined period.

(Step S701) The CPU 102 determines whether the posture of the pedometer 100 has changed, on the basis of the result of the posture determination process. If the CPU 102 determines that the posture of the pedometer 100 has changed, the process proceeds to step S702. Otherwise, the processing in step S701 is performed again.

(Step S702) The CPU 102 determines whether the posture of the pedometer 100 has changed at least a fixed number of times within a predetermined period. If the CPU 102 determines that the posture of the pedometer 100 has changed at least the fixed number of times within the predetermined period, the process proceeds to step S703; otherwise, the process returns to step S701.

The processing in steps S703 and S704 is identical to the processing in steps S502 and S503 shown in FIG. 11.

In this manner, the pedometer 100 stops the walk detecting operation when the posture has changed at least a fixed number of times. This decreases the possibility that the walk detecting operation is stopped due to an accidental change in posture of the pedometer 100.

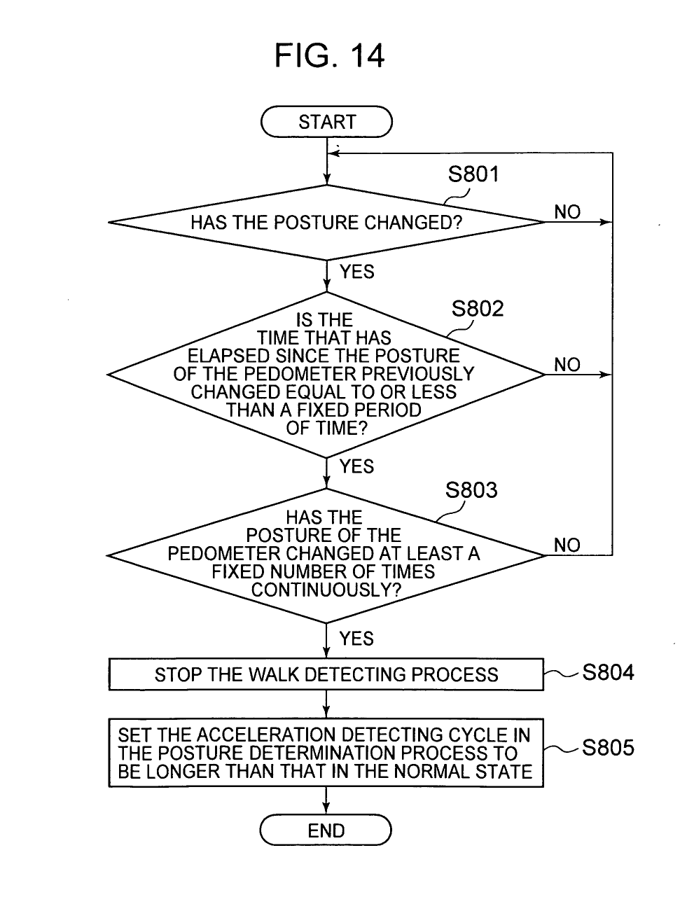

FIG. 14 is a flowchart illustrating processing procedure, in the present embodiment, for stopping the walk detecting process in the case where the posture of the pedometer 100 has changed within a fixed period of time and the posture has changed at least a fixed number of times continuously within the fixed period of time.

(Step S801) The CPU 102 determines whether the posture of the pedometer 100 has changed, on the basis of the result of the posture determination process. If the CPU 102 determines that the posture of the pedometer 100 has changed, the process proceeds to step S802. Otherwise, the processing in step S801 is performed again.

(Step S802) The CPU 102 determines whether the time that has elapsed since the posture of the pedometer 100 changed previously is a fixed period of time or less. If the CPU 102 determines that the time that has elapsed from the previous change in posture of the pedometer 100 is equal to or less than the fixed period of time, the process proceeds to step S803; otherwise, the process returns to step S801.

(Step S803) The CPU 102 determines whether the posture of the pedometer 100 has changed at least a fixed number of times continuously. If the CPU 102 determines that the posture of the pedometer 100 has changed at least the fixed number of times continuously, the process proceeds to step S804; otherwise, the process returns to step S801.

The processing in steps S804 and S805 is identical to the processing in steps S502 and S503 shown in FIG. 11.

In this manner, the pedometer 100 stops the walk detecting operation in the case where the posture has changed within a fixed period of time and further the posture has changed at least a fixed number of times continuously within the fixed period of time. This decreases the possibility that the walk detecting operation is stopped due to an accidental change in posture of the pedometer 100.

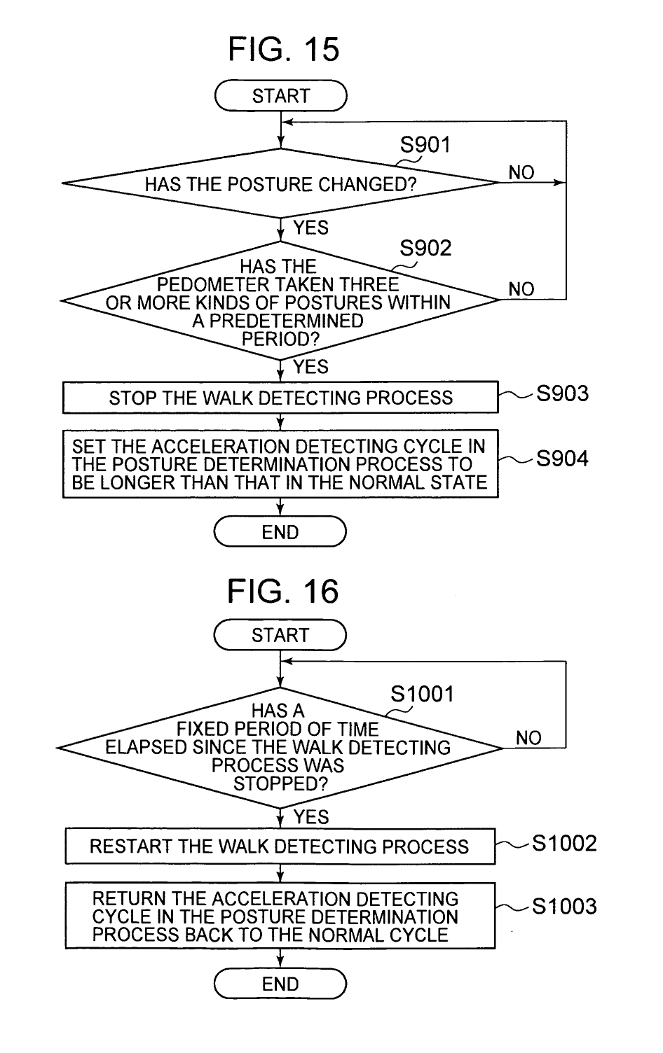

FIG. 15 is a flowchart illustrating processing procedure, in the present embodiment, for stopping the walk detecting process in the case where the pedometer 100 has taken at least a fixed number of kinds of postures within a predetermined period.

(Step S901) The CPU 102 determines whether the posture of the pedometer 100 has changed, on the basis of the result of the posture determination process. If the CPU 102 determines that the posture of the pedometer 100 has changed, the process proceeds to step S902. Otherwise, the processing in step S901 is performed again.

(Step S902) The CPU 102 determines whether the pedometer 100 has taken three or more kinds of postures within a predetermined period. If the CPU 102 determines that the pedometer 100 has taken three or more kinds of postures within the predetermined period, the process proceeds to step S903; otherwise, the process returns to step S901.

The processing in steps S903 and S904 is identical to the processing in steps S502 and S503 shown in FIG. 11.

In this manner, the pedometer 100 stops the walk detecting process in the case where the pedometer has taken at least a fixed number of kinds of postures within a predetermined period. This decreases the possibility that the walk detecting operation is stopped due to an accidental change in posture of the pedometer 100.

Hereinafter, processing performed by the CPU 102 for restarting the walk detecting process after it once stopped the same will be described. In the following, three examples will be described with reference to FIGS. 16 to 18.

FIG. 16 is a flowchart illustrating processing procedure, in the present embodiment, for restarting the walk detecting process in the case where a fixed period of time has elapsed since the walk detecting process was stopped.

(Step S1001) The CPU 102 determines whether a fixed period of time has elapsed since the walk detecting process was stopped. If the CPU 102 determines that the fixed period of time has elapsed since the walk detecting process was stopped, the process proceeds to step S1002. Otherwise, the processing in step S1001 is performed again.

(Step S1002) The CPU 102 restarts the walk detecting process. The process then proceeds to step S1003.

(Step S1003) In the case where the CPU 102 had set the acceleration detecting cycle in the posture determination process to be longer than that in the walk detecting process, the CPU 102 returns the acceleration detecting cycle in the posture determination process back to the normal cycle which is applied while a walk is being detected. The process is then terminated.

In this manner, the pedometer 100 is able to restart the walk detecting process after it once stopped the same.

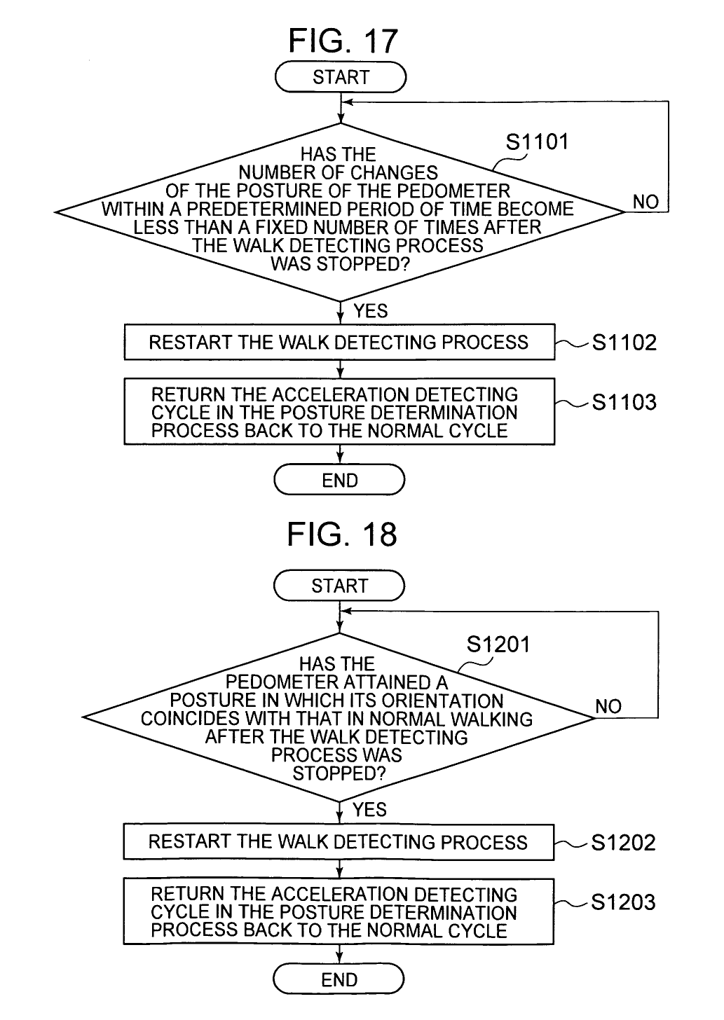

FIG. 17 is a flowchart illustrating processing procedure, in the present embodiment, for restarting the walk detecting process in the case where the number of changes of the posture of the pedometer 100 within a predetermined period has become less than a fixed number of times after the walk detecting process was stopped.

(Step S1101) The CPU 102 determines whether the number of changes of the posture of the pedometer 100 within a predetermined period of time has become less than a fixed number of times after the walk detecting process was stopped. If the CPU 102 determines that the number of changes of the posture of the pedometer 100 within the predetermined period of time has become less than the fixed number of times after the walk detecting process was stopped, the process proceeds to step S1102. Otherwise, the processing in step S1101 is performed again.

The processing in steps S1102 and S1103 is identical to the processing in steps S1002 and S1003 shown in FIG. 16.

In this manner, the pedometer 100 is able to restart the walk detecting process after it once stopped the same.

FIG. 18 is a flowchart illustrating processing procedure, in the present embodiment, for restarting the walk detecting process in the case where the pedometer 100 has attained a posture in which its orientation coincides with that in normal walking after the walk detecting process was stopped.

(Step S1201) The CPU 102 determines whether the pedometer 100 has attained a posture in which its orientation corresponds to that in normal walking after the walk detecting process was stopped. If the CPU 102 determines that the pedometer 100 has attained the posture in which its orientation coincides with that in normal walking, the process proceeds to step S1202. Otherwise, the processing in step S1201 is performed again. For example, the orientation of the pedometer 100 in normal walking corresponds to its orientation in the posture “e”.

The processing in steps S1202 and S1203 is identical to the processing in steps S1002 and S1003 shown in FIG. 16.

In this manner, the pedometer 100 is able to restart the walk detecting process after it once stopped the same. It is noted that the pedometer 100 may be configured to restart the walk detecting process when the input unit 103 accepts an input from the user after the pedometer 100 has once stopped the walk detecting process.

As described above, according to the present embodiment, the pedometer 100 determines that a user has stopped walking or running, on the basis of the posture of the pedometer 100. Therefore, even if the acceleration sensors 106 to 108 output signals, the pedometer 100 is able to keep the walk detecting process stopped, without determining that the user has started walking or running. Accordingly, even in the state where the pedometer 100 is being worn by a user, the pedometer 100 is able to determine that the user has stopped walking or running, and thus to stop the walk detecting process. This enables a further reduction in power consumption.

It is noted that some or all of the functions of the units included in the pedometer 100 of the above-described embodiment may be implemented by recording a program for implementing these functions on a computer-readable recording medium and by causing a computer system to read and execute the program recorded on the recording medium. As used herein, the “computer system” includes an operating system (OS) as well as hardware such as peripheral equipment.

Further, the “computer-readable recording medium” includes removable media such as a flexible disk, a magneto-optical disk, a ROM, and a CD-ROM, and a storage such as a hard disk included in the computer system. The “computer-readable recording medium” may further include one which dynamically stores a program for a short period of time, like a communication line in the case where the program is transmitted via the Internet or other network or a telephone line or other telecommunication circuit, and in such a case, the “computer-readable recording medium” may further include one which stores the program for a predetermined period of time, like a volatile memory within a computer system serving as a server or a client. Still further, the program may be one which implements a part of the above-described functions, or one which implements the functions by combination with the program that has already been recorded on the computer system.

It is noted that the present invention is not restricted to the above-described embodiment, but various modifications are possible within the scope not departing from the spirit of the present invention. For example, while the wristwatch-type pedometer as shown in FIG. 1 has been described as an example of the electronic device in the above embodiment, not restricted thereto, the electronic device may be of any kind as long as it is worn by a user's arm for use.

What is claimed is:

1. An electronic device comprising:
a first acceleration sensor which detects an acceleration in a first direction to output a first signal corresponding to the acceleration;
a second acceleration sensor which detects an acceleration in a second direction orthogonal to the first direction to output a second signal corresponding to the acceleration;
a third acceleration sensor which detects an acceleration in a third direction orthogonal to a plane uniquely identified by the first and second directions to output a third signal corresponding to the acceleration;
a walk detecting unit which obtains one or more signals from among the first, second, and third signals to detect a walk by using the obtained signals;
a posture determination unit which obtains the first, second, and third signals to determine a posture of the electronic device on the basis of a moving average value of the first signals, a moving average value of the second signals, and a moving average value of the third signals; and
a control unit which stops an operation of the walk detecting unit on the basis of a change of the posture determined by the posture determination unit.

2. The electronic device according to claim 1, wherein the control unit controls such that, while the operation of the walk detecting unit is being stopped, the signals are obtained in a cycle which is longer than a cycle that is applied while the walk detecting unit is in operation.

3. The electronic device according to claim 1, wherein the control unit stops power supply to the walk detecting unit while the control unit stops the operation of the walk detecting unit.

4. The electronic device according to claim 2, wherein the control unit stops power supply to the walk detecting unit while the control unit stops the operation of the walk detecting unit.

5. The electronic device according to claim 1, wherein the control unit stops the operation of the walk detecting unit in the case where the posture determined by the posture determination unit has changed at least a fixed number of times within a predetermined period.

6. The electronic device according to claim 2, wherein the control unit stops the operation of the walk detecting unit in the case where the posture determined by the posture determination unit has changed at least a fixed number of times within a predetermined period.

7. The electronic device according to claim 3, wherein the control unit stops the operation of the walk detecting unit in the case where the posture determined by the posture determination unit has changed at least a fixed number of times within a predetermined period.

8. The electronic device according to claim 4, wherein the control unit stops the operation of the walk detecting unit in the case where the posture determined by the posture determination unit has changed at least a fixed number of times within a predetermined period.

9. The electronic device according to claim 1, wherein the control unit stops the operation of the walk detecting unit in the case where the posture determined by the posture determination unit has changed within a fixed period of time and the posture has changed at least a fixed number of times continuously within the fixed period of time.

10. The electronic device according to claim 2, wherein the control unit stops the operation of the walk detecting unit in the case where the posture determined by the posture determination unit has changed within a fixed period of time and the posture has changed at least a fixed number of times continuously within the fixed period of time.

11. The electronic device according to claim 1, wherein the control unit stops the operation of the walk detecting unit in the case where the posture determined by the posture determination unit has changed within a fixed period of time and the posture has changed at least a fixed number of times continuously within the fixed period of time.

12. The electronic device according to claim 1, wherein the control unit stops the operation of the walk detecting unit in the case-where the posture determination unit has determined at least a fixed number of kinds of postures within a predetermined period.

13. The electronic device according to claim 1, wherein the control unit restarts the operation of the walk detecting unit when a fixed period of time has elapsed since the control unit stopped the operation of the walk detecting unit.

14. The electronic device according to claim 1, wherein the control unit restarts the operation of the walk detecting unit in the case where the number of changes of the posture determined by the posture determination unit within a predetermined period has become less than a fixed number of times after the control unit stopped the operation of the walk detecting unit.

15. The electronic device according to claim 13, wherein in the case where the control unit had controlled such that the signals would be obtained in a cycle which is longer than an original cycle that is applied while the walk detecting unit is in operation, the control unit returns the cycle back to the original cycle when restarting the operation of the walk detecting unit.

16. The electronic device according to claim 13, wherein in the case where the control unit had stopped the power supply to the walk detecting unit, the control unit restarts the power supply to the walk detecting unit when restarting the operation of the walk detecting unit.

17. The electronic device according to claim 1, further comprising an input unit which accepts an input from a user, wherein
after the control unit has stopped the operation of the walk detecting unit, the control unit restarts the operation of the walk detecting unit in the case where the input unit has accepted an input.

18. The electronic device according to claim 1, wherein after the control unit has stopped the operation of the walk detecting unit, the control unit restarts the operation of the walk detecting unit in the case where the posture determination unit determines that the device has attained a predetermined posture.

19. A pedometer comprising:
a first acceleration sensor which detects an acceleration in a first direction to output a first signal corresponding to the acceleration;
a second acceleration sensor which detects an acceleration in a second direction orthogonal to the first direction to output a second signal corresponding to the acceleration;
a third acceleration sensor which detects an acceleration in a third direction orthogonal to a plane uniquely identified by the first and second directions to output a third signal corresponding to the acceleration;
a walk detecting unit which obtains one or more signals from among the first, second, and third signals to detect a walk by using the obtained signals;
a posture determination unit which obtains the first, second, and third signals to determine a posture of the pedometer on the basis of a moving average value of the first signals, a moving average value of the second signals, and a moving average value of the third signals; and
a control unit which stops an operation of the walk detecting unit on the basis of a change of the posture determined by the posture determination unit.

20. A program for causing a computer to perform:
a first acceleration detecting step of detecting an acceleration in a first direction to output a first signal corresponding to the acceleration;
a second acceleration detecting step of detecting an acceleration in a second direction orthogonal to the first direction to output a second signal corresponding to the acceleration;
a third acceleration detecting step of detecting an acceleration in a third direction orthogonal to a plane uniquely identified by the first and second directions to output a third signal corresponding to the acceleration;
a walk detecting step of obtaining one or more signals from among the first, second, and third signals to detect a walk by using the obtained signals;
a posture determination step of obtaining the first, second, and third signals to determine a posture of the own device on the basis of a moving average value of the first signals, a moving average value of the second signals, and a moving average value of the third signals; and
a control step of stopping an operation of the walk detecting step on the basis of a change of the posture determined in the posture determination step.
